(19) United States
(12) Patent Application Publication
(10) Pub. No.: US 2009/0290477 A1
(43) Pub. Date: Nov. 26, 2009

(54) OPTICAL DISK REPRODUCING DEVICE

(76) Inventor: Michinori Sato, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 11/910,338

(22) PCT Filed: Apr. 3, 2006
(86) PCT No.: PCT/JP2006/307059

§ 371 Date: Oct. 1, 2007

(30) Foreign Application Priority Data
Apr. 8, 2005 (JP) 2005-111985

(51) Int. Cl. G11B 7/135

(52) U.S. Cl. 369/112.23; G9B/7.112

(57) ABSTRACT

An optical disk reproduction apparatus according to the present invention is an optical disk reproduction apparatus capable of reading information from the NBCA of an optical disk 101 having an NBCA, and includes: an optical pickup 103 having an objective lens 120 for converging a light beam onto the optical disk 101, a lens actuator 170 for controlling a position of the objective lens 120, and a photodetector for generating an electrical signal from at least a portion of the light beam having been reflected by the optical disk 101; a transport mechanism 106 for moving the optical pickup 103 along a radial direction of the optical disk; and an NBCA in/out determination section 104 for, based on electrical signal, determining whether an irradiated position of the light beam on the optical disk 101 is located within the NBCA or not. When reading information from the NBCA, it executes: step A of, by using the transport mechanism 106, moving the optical pickup 103 from a first pickup position to a second pickup position which is close to the disk center; step B of, by using the lens actuator 170, placing the objective lens 120 consecutively at a plurality of positions within the optical pickup 103 being at the second pickup position; and step C of, by using the NBCA in/out determination section 104, determining whether an irradiated position on the optical disk 101 of the light beam converged by the objective lens 120 is located within the NBCA or not.

### TECHNICAL FIELD

The present invention relates to an optical disk reproduction apparatus and a driving method thereof.

### BACKGROUND ART

Data which is recorded on an optical disk is reproduced by irradiating the rotating optical disk with a light beam having a relatively weak constant light amount, and detecting reflected light which has been modulated by the optical disk.

On a read-only optical disk, information in the form of pits is recorded in a spiral manner, previously during manufacture of the optical disk. On the other hand, in the case of a rewritable optical disk, a method such as vapor deposition is used to deposit a film of recording material which allows for optical data recording/reproduction, on the surface of a base on which a track having spiral land or groove is formed. In the case where data is to be recorded on a rewritable optical disk, the optical disk is irradiated with a light beam whose light amount is modulated in accordance with the data to be recorded, thus causing local changes in the characteristics of the recording material film, whereby a data write is effected.

Note that the depth of the pits, the depth of the track, and the thickness of the recording material film are small relative to the thickness of the base of the optical disk. Therefore, any portion of the optical disk where data is recorded constitutes a two-dimensional surface, and may be referred to as a “recording surface” or an “information surface”. In the present specification, since such a surface has a physical size along the depth direction, the term “information layer” will be employed, instead of “recording surface (information surface)”. An optical disk includes at least one such information layer. Note that one information layer may actually include a plurality of layers, e.g., a phase-change material layer and a reflective layer.

When reproducing data which is recorded on an optical disk, or recording data onto a recordable optical disk, it is necessary for a light beam to always retain a predetermined convergence state on a target track on the information layer. This requires “focus control” and “tracking control”. “Focus control” refers to controlling the position of an objective lens along a normal direction of the information surface so that a focal point of the light beam (convergence point) is always positioned on the information layer. On the other hand, tracking control refers to controlling the position of an objective lens along a radial direction of the optical disk (hereinafter referred to as the “disk radial direction”) so that a spot of the light beam is positioned on a predetermined track.

As conventional high-density/large-capacity optical disks, optical disks such as DVD (Digital Versatile Disc)-ROMs, DVD-RAMs, DVD-RWs, DVD-Rs, DVD+RWs, and DVD+Rs have been put to practical use. In addition, CDs (Compact Discs) are still in use. Currently, next-generation optical disks which have a higher density and a larger capacity than those of the above optical disks are being developed and put to practical applications, e.g., Blu-ray Discs (BDs) and HD-DVDs.

Some optical disks have an area called a Burst Cutting Area (BCA: Burst Cutting Area) or a Narrow Burst Cutting Area (NBCA: Narrow Burst Cutting Area). DVD-RAMs and DVD-ROMs have a BCA, whereas DVD-Rs and DVD-RWs have an NBCA.

The BCA or NBCA is formed by processing a portion of a reflective layer near the innermost periphery position of the optical disk, and has a bar-code like slit pattern. In such a slit pattern, information that is unique to each individual optical disk is recorded. The BCA or NBCA pattern is formed during the manufacture of the optical disk, and it is impossible for a usual optical disk apparatus to rewrite the slit pattern.

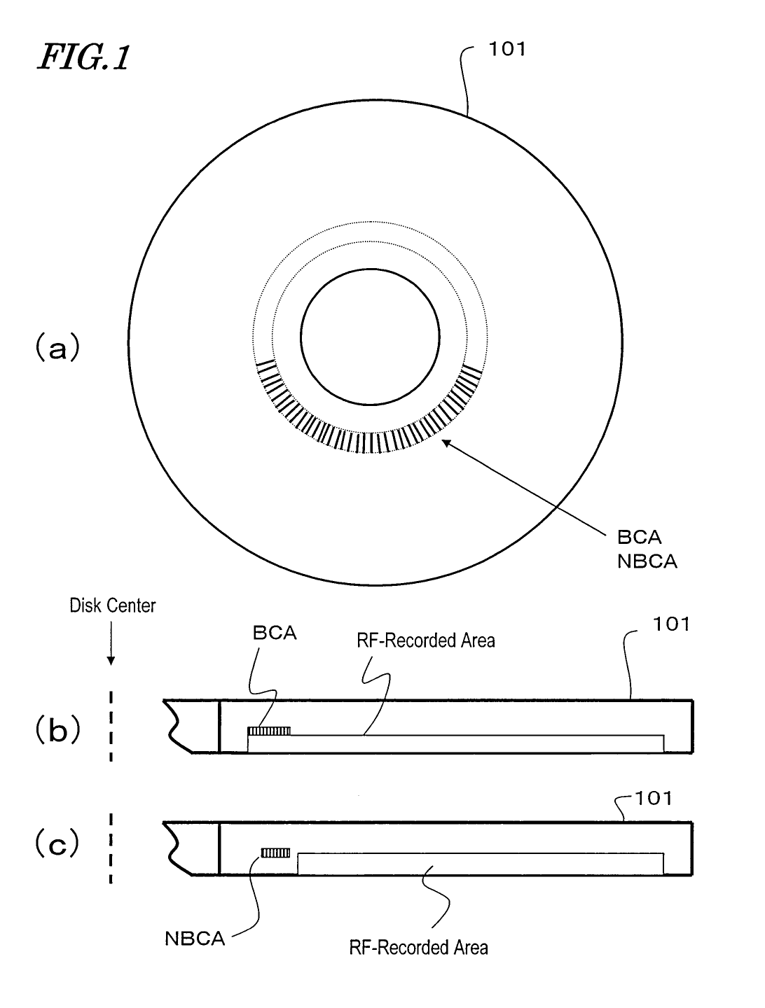

FIG. 1(a) is a plan view schematically showing an upper face of the optical disk 101 having a BCA or NBCA. FIG. 1(a) exaggerates the BCA or NBCA to be larger than its actual size. The BCA is formed in an area spanning radial positions from 22.3 to 23.5 mm, whereas the NBCA is formed in an area spanning radial positions from 22.71 to 23.51 mm. Therefore, the width (size along the radial direction) of the BCA is about 1200 μm, and the width (size along the radial direction) of the NBCA is about 800 μm. These widths are as large as more than 1000 times the track pitch.

A reflection film which is formed in the BCA or NBCA has a slit width of about 30 to about 120 μm. Although depending on the rotation speed of the optical disk, the modulation frequency of the light amount amplitude of a light beam which is reflected by the BCA or NBCA is typically as large as about 28 kHz to about 112 kHz. On the other hand, the modulation frequency of the light amount amplitude of a light beam which is reflected from an area where the main information such as user data is recorded is sufficiently higher than the aforementioned frequency range, and thus a reproduction signal of the main information is a “high-frequency signal”. Therefore, in the present specification, an area in which main information such as user data is recorded will be referred to as an “RF-recorded area”. A signal which is reproduced from an RF-recorded area may contain various information, but usually contains address information such as a sector address. The address information is used in order to detect which track an irradiated position of the light beam is located on.

Note that, in some cases, encrypted user data may be written to the RF-recorded area. In such cases, decryption is performed by using information that is unique to each individual optical disk, which is recorded in the BCA or NBCA, as an encryption key. Therefore, unless the optical disk apparatus is able to move the irradiated position of a light beam to above the BCA or NBCA, and accurately read the information that is recorded in the BCA or NBCA, the information which is recorded in the RF-recorded area cannot be read and decrypted.

An optical disk apparatus which is capable of reading information from the BCA or NBCA will, before performing an operation of reproducing data from or writing user data to an RF-recorded are a of a loaded optical disk, access the BCA or NBCA in order to read the information which is recorded in the BCA or NBCA. The information which is recorded in the BCA or NBCA is utilized for generating an encryption key, or determining whether reproduction is permitted or not.

FIG. 1(b) is a partial cross-sectional view of an optical disk 101 schematically showing relative positions of the BCA and the RF-recorded area. FIG. 1(c) is a partial cross-sectional view of the optical disk 101 schematically showing relative positions of the NBCA and the RF-recorded area.

In a DVD-ROM or DVD-RAM, as shown in FIG. 1(b), the BCA is formed so as to overlap the RF-recorded area. In other words, the BCA is located within a lead-in area of the RF-recorded area. On the other hand, as shown in FIG. 1(c), the NBCA is formed at a position which is closer to the disk center than is the RF-recorded area, there being no overlap with the RF-recorded area.

Since a track extending in a spiral shape exists in the RF-recorded area, it is possible to generate a tracking error signal from the RF-recorded area. On the other hand, no information track is formed and no RF signal is recorded in the area which is closer to the disk center than is the RF-recorded area. For this reason, the area which is closer to the disk center than is the RF-recorded area may be referred to as an “RF-unrecorded area”. Since no tracking error signal can be reproduced from such an RF-unrecorded area, tracking servo control cannot be performed.

Since the NBCA is formed in the “RF-unrecorded area”, tracking servo control can no longer be performed after the irradiated position of a light beam is moved to above the NBCA. However, the NBCA has a width (size along the radial direction) as much as about 800 μm, as described above. Therefore, if the irradiated position of a light beam can be moved to above the NBCA, even in an OFF state of tracking servo control, the irradiated position of the light beam will not deviate from the NBCA over a short period of time, and thus the information in the NBCA can be read.

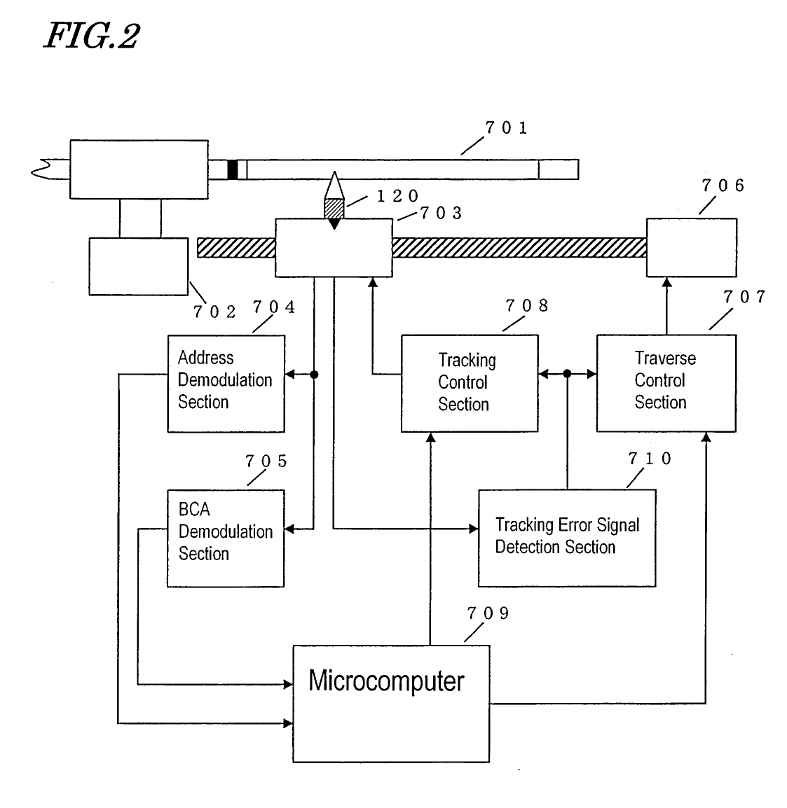

Next, with reference to FIG. 2, the construction of a conventional optical disk reproduction apparatus, which is capable of reproducing data from the BCA of an optical disk 701 having a BCA, will be described.

The optical disk reproduction apparatus of FIG. 2 includes: a motor 702 for rotating the optical disk 701; an optical pickup 703 for irradiating the optical disk 701 with a light beam, and generating an electrical signal from the reflected light; a transport mechanism 706 for moving a base of the optical pickup 703 along a radial direction of the optical disk 701; and a control section 200 for controlling the aforementioned constituent elements.

The optical pickup 703 includes: a light source (not shown) for emitting a light beam; an objective lens 120 for converging the light beam; a lens actuator (not shown) for controlling the position of the objective lens 120; and a light amount detector (not shown) for generating an electrical signal from at least a portion of the light beam having been reflected from the optical disk 701.

The control section 200 includes: an address demodulation section 704 for demodulating a sector address which is contained in the main information based on the electrical signal generated by the optical pickup 703; a BCA demodulation section 705 for demodulating a BCA signal from the aforementioned electrical signal; a traverse control section 707 for controlling the position of the optical pickup 703 by driving the transport mechanism 706; a tracking control section 708 for controlling the position of the objective lens in the optical pickup 703 along the radial direction of the optical disk 701; and a microcomputer 709 for controlling these operations.

In order to reproduce a BCA signal from the BCA of the optical disk 701, the microcomputer 709 causes the optical pickup 703 to move toward the disk's inner periphery side in accordance with the sector address which has been demodulated by the address demodulation section 704, whereby the irradiated position of the light beam arrives at the BCA. At this time, the optical pickup 703 is moved by using the traverse control section 707 and the tracking control section 708. When the irradiated position of the light beam arrives at the BCA, based on the light beam reflected from the BCA, the BCA demodulation section 705 performs demodulation of the BCA signal, whereby the data which is recorded in the BCA is read.

When demodulating the sector address and demodulating the BCA, the microcomputer 709 keeps the tracking servo control in an ON state. When tracking servo control is in an ON state, the tracking control section 708 controls the position (position along the disk radial direction) of the objective lens 120 based on a tracking error signal which is detected by the tracking error signal detection section 710, and the traverse control section 707 controls the position (position along the disk radial direction) of the base of the optical pickup 703. As a result, the irradiated position of the light beam is placed on a target track of the optical disk 701.

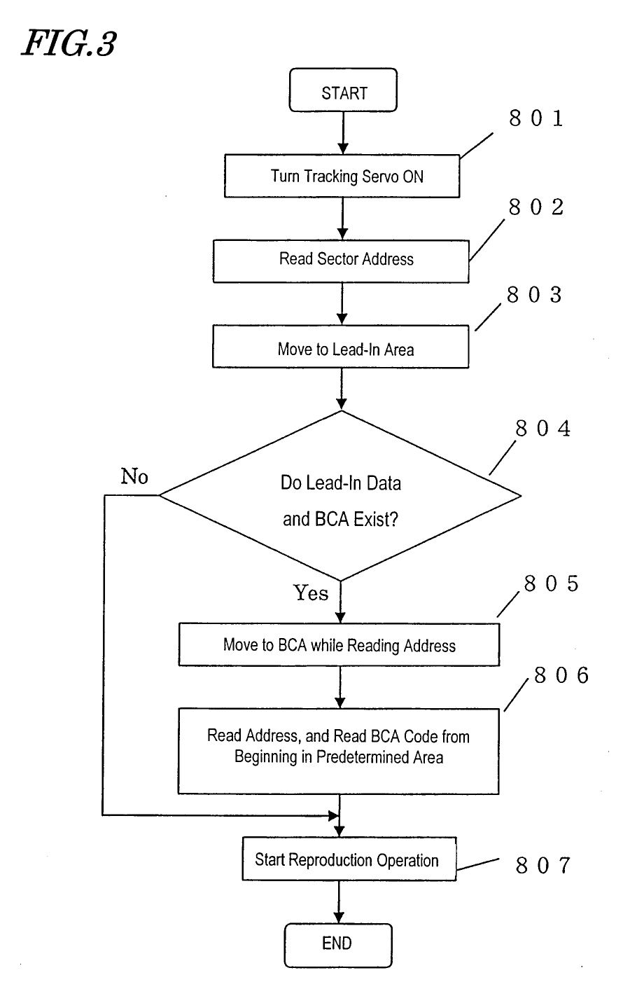

Next, with reference to FIG. 3, an operation of the optical disk reproduction apparatus of FIG. 2 will be described.

First, after adjusting the position of the optical pickup 703 so that the irradiated position of the light beam comes within the RF-recorded area of the optical disk 701, tracking servo control is placed in an ON state at step 801. The tracking servo control is performed by the tracking control means 708 of FIG. 2. Thereafter, at step 802, the address demodulation section 704 reads a sector address from the RF-recorded area of the optical disk 701. Based on this sector address, the irradiated position of the light beam on the optical disk 701 can be accurately known.

At step 803, the irradiated position of the light beam is moved to the lead-in area, which is located toward the innermost periphery side of the RF-recorded area of the optical disk 701. Presence/absence of the BCA is recorded in the lead-in area. If it is determined at step 804 that “BCA exists” from the content of the lead-in data, at step 805, the irradiated position of the light beam is moved to the BCA of the optical disk 701 while reading the addresses. During this move, tracking servo control is kept OFF, and the number of tracks traversed by the light beam is counted. When a predetermined number of tracks have been traversed, it can be determined that the irradiated position of the light beam has come into the BCA. When it is determined based on the number of traversed tracks that the irradiated position of the light beam has come into the BCA, tracking servo control is activated and an address is read from the optical disk 701. Based on this address, it can be confirmed whether the BCA has been reached or not.

At step 806, if it is confirmed that the irradiated position of the light beam has arrived at the BCA, the BCA demodulation circuit 705 of FIG. 2 reads BCA code from the BCA.

Next, after the optical pickup 703 is moved by the traverse control section 707 so that the irradiated position of the light beam is returned to the RF-recorded area, a reproduction operation is begun at step 807. The reproduction operation is carried out by using the BCA code.

If it is determined at step 804 that “BCA does not exit” from the content of the lead-in data, the irradiated position of the light beam is moved to the RF-recorded area, and the reproduction operation of step 807 is begun.

Note that, although tracking servo control is temporarily placed in an OFF state when performing the move to the lead-in area at step 803 and the move to the BCA at step 805, tracking is kept in an ON state while performing a read of the addresses and the BCA.

A method for detecting whether or not the irradiated position of the light beam has arrived at the BCA or NBCA is disclosed in Patent Document 2.
[Patent Document 1] Japanese Laid-Open Patent Publication No. 2001-222821 (FIG. 14)
[Patent Document 2] Pamphlet of International Publication No. WO 05/122150

### DISCLOSURE OF INVENTION

### Problems to be Solved by the Invention

The above-described optical disk reproduction apparatus may be able to read the BCA, but is not able to read the NBCA, which is located in an area that is closer to the disk center than is the RF-recorded area. The reason is that no track exists at the position where the NBCA is formed, so that no sector addresses to be contained in the RF signal are assigned.

In order to read the NBCA by using the conventional optical disk apparatus, after moving the irradiated position of the light beam to the innermost peripheral edge of the RF-recorded area, the irradiated position of the light beam may be moved toward the disk center from that position, by a distance corresponding to a predetermined number of tracks. Tracking servo control needs to be performed in order to accurately move the irradiated position of the light beam by the predetermined number of tracks, but no tracking error signal can be obtained from the RF-unrecorded area where no track exists as mentioned above.

In order to solve this problem, a high-performance motor (e.g., a stepping motor) having a high positioning accuracy is needed that is capable of moving the optical pickup along the disk radial direction very accurately. However, a motor having a high positioning accuracy such as a stepping motor is expensive, and in a usual optical disk reproduction apparatus, a motor having a high positioning accuracy will not be needed other than for the read operation of the NBCA. Therefore, in order to avoid any cost increase due to an unnecessary function, a DC motor which has a relatively low positioning accuracy and is inexpensive is employed in commonly-used optical disk reproduction apparatuses.

Under the above circumstances, in the case where the transport mechanism for the optical pickup is constructed by using a DC motor having a low positioning accuracy, it is impossible to accurately move the irradiated position of the light beam from the innermost peripheral edge of the RF-recorded area toward the disk center by a distance corresponding to the predetermined number of tracks. The distance (gap) from the innermost peripheral edge of the RF-recorded area to the NBCA is about 300 μm. Even if a traverse operation of the optical pickup is performed so as to aim at the central portion of the NBCA, the distance which is actually traveled by the optical pickup will be uncertain (about 100 to about 300 μm), and it is not possible to detect the position of the optical pickup at the destination of the move. Therefore, unless employing an expensive motor such as a stepping motor, it would be impossible to produce an optical disk reproduction apparatus that is capable of reading the NBCA information, thus presenting a problem in that encrypted data in the RF-recorded area cannot be decrypted in inexpensive popularly-priced products.

Moreover, even if a traverse operation of the optical pickup is performed so as to aim at the central portion of the NBCA, and a successful move to near the center of the NBCA has taken place with a relatively good reproducibility, there may still occur a problem when the NBCA data fails to be appropriately reproduced because of the dust particles or scratches that are present in the NBCA at that position. This problem occurs because the minimum travel distance of the optical pickup using a DC motor cannot be set to a value that is smaller than a predetermined distance (which is typically 300 μm). In other words, even if a necessary electrical signal is supplied to the DC motor with the purpose of moving the optical pickup by just 50 μm, the DC motor will not be driven at all, and no minute move of the optical pickup will occur. Therefore, even if the optical pickup manages to be moved to near the center of the NBCA, if the NBCA data cannot be read from that position, the position of the optical pickup cannot be finely displaced within the NBCA.

Such a problem occurs notably in connection with the NBCA. However, also in the case of reading the BCA with the apparatus of FIG. 2, tracking servo control may become unstable at the slit portions of the BCA, thus resulting in the problem of being unable to surely move the irradiated position of the light beam to the BCA.

The present invention has been made in view of the above problems, and provides an optical disk reproduction apparatus which is capable of stably reading the NBCA or BCA in the case where tracking servo control cannot be performed in a portion where the RF signal is unrecorded.

### Means for Solving the Problems

An optical disk reproduction apparatus according to the present invention is an optical disk reproduction apparatus for, from an optical disk having an Burst Cutting Area, reading information from the Burst Cutting Area, comprising: an optical pickup having: a light source for emitting a light beam, an objective lens for converging the light beam onto the optical disk, a lens actuator for controlling a position of the objective lens, and a photodetector for generating an electrical signal from at least a portion of the light beam having been reflected by the optical disk; a transport mechanism for moving the optical pickup along a radial direction of the optical disk; and area determination means for, based on the electrical signal, determining whether an irradiated position of the light beam on the optical disk is located within the Burst Cutting Area, wherein, when reading information from the Burst Cutting Area, the optical disk reproduction apparatus executes: step A of, by using the transport mechanism, moving the optical pickup from a first pickup position to a second pickup position which is close to the disk center; step B of, by using the lens actuator, placing the objective lens consecutively at a plurality of different lens positions within the optical pickup being at the second pickup position; and step C of, by using the area determination means, determining whether an irradiated position on the optical disk of the light beam converged by the objective lens is located within the Burst Cutting Area or not.

In a preferred embodiment, an interval between the plurality of lens positions within the optical pickup is set to be shorter than a distance from the first pickup position to the second pickup position.

In a preferred embodiment, when it is determined at step C that the irradiated position of the light beam on the optical disk is not located within the Burst Cutting Area, the optical disk reproduction apparatus executes: step D of, by using the transport mechanism, bringing the optical pickup further closer to the disk center; step E of, by using the lens actuator, placing the objective lens consecutively at a plurality of different lens positions within the optical pickup; and step F of, by using the area determination means, determining whether an irradiated position on the optical disk of the light beam converged by the objective lens is located within the Burst Cutting Area or not.

In a preferred embodiment, an interval between the plurality of lens positions within the optical pickup is set to be shorter than a distance traveled by the optical pickup at step D.

In a preferred embodiment, when placing the objective lens consecutively at a plurality of different lens positions within the optical pickup by using the lens actuator, the optical disk reproduction apparatus executes a step of bringing the objective lens closer to the disk center, the step being executed a plurality of times.

In a preferred embodiment, when placing the objective lens consecutively at a plurality of different lens positions within the optical pickup by using the lens actuator, the optical disk reproduction apparatus executes a step of bringing the objective lens away from the disk center, the step being executed at least once.

In a preferred embodiment, the first pickup position is located more toward an outer periphery of the disk than an innermost peripheral edge of a reproduction signal recorded area.

In a preferred embodiment, based on a change in the light amount of the light beam having been reflected by the optical disk, the area determination means determines whether the irradiated position of the light beam on the optical disk is located within the Burst Cutting Area or not.

In a preferred embodiment, if the irradiated position of the light beam on the optical disk is determined to be located within the Burst Cutting Area, the optical disk reproduction apparatus executes, before reading information from the Burst Cutting Area, an operation of bringing the irradiated position of the light beam closer to a central portion of the Burst Cutting Area.

In a preferred embodiment, the Burst Cutting Area is a Narrow Burst Cutting Area.

In a preferred embodiment, the transport mechanism includes a DC motor, and the optical pickup is moved along the radial direction of the optical disk by a rotation of the DC motor.

An driving method for an optical disk reproduction apparatus according to the present invention is a driving method for an optical disk reproduction apparatus which includes an optical pickup having: a light source for emitting a light beam, an objective lens for converging the light beam onto the optical disk, a lens actuator for controlling a position of the objective lens, and a photodetector for generating an electrical signal from at least a portion of the light beam having been reflected from the optical disk, the driving method comprising: when reading, from an optical disk having a Burst Cutting Area, information from the Burst Cutting Area, step A of moving the optical pickup from a first pickup position to a second pickup position which is close to the disk center; step B of, by using the lens actuator, placing the objective lens consecutively at a plurality of different lens positions within the optical pickup being at the second pickup position; and step C of determining whether an irradiated position on the optical disk of the light beam converged by the objective lens is located within the Burst Cutting Area or not.

### EFFECTS OF THE INVENTION

According to the present invention, by allowing the irradiated position of a light beam to be finely displaced while not performing tracking servo control, it becomes possible to surely bring the irradiated position of the light beam to the NBCA or BCA, without employing an expensive motor having a high positioning accuracy.

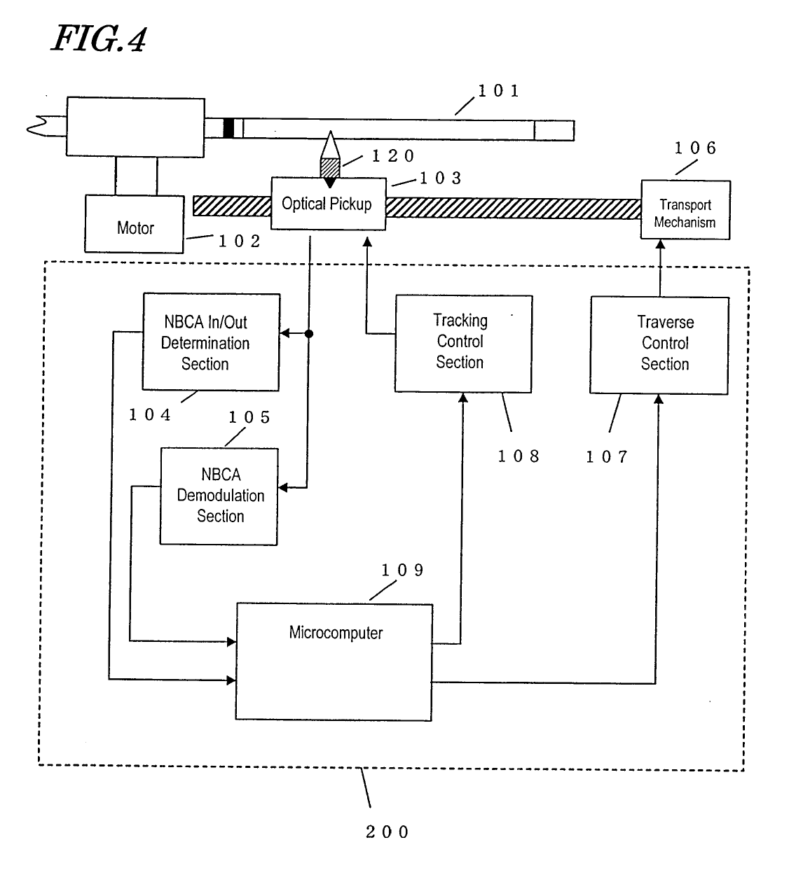

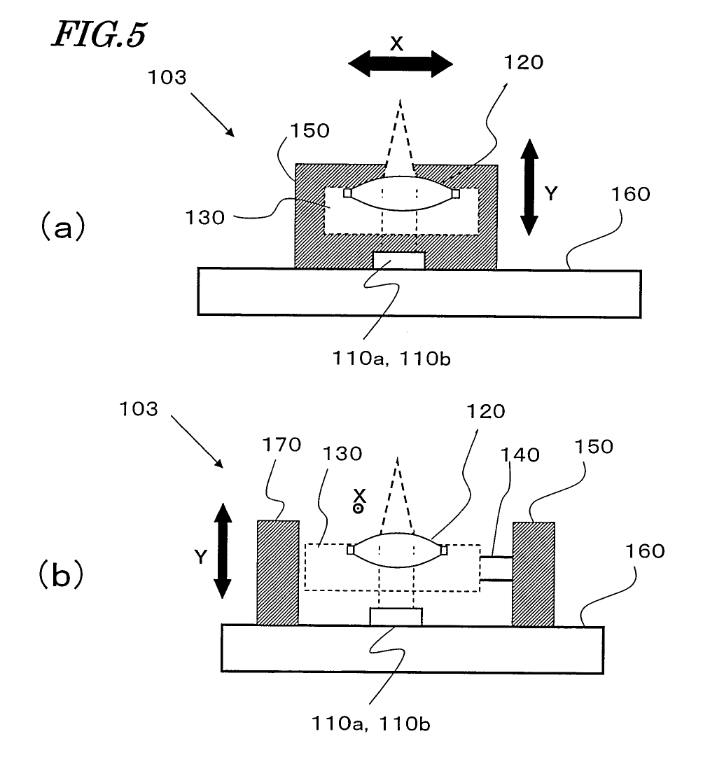

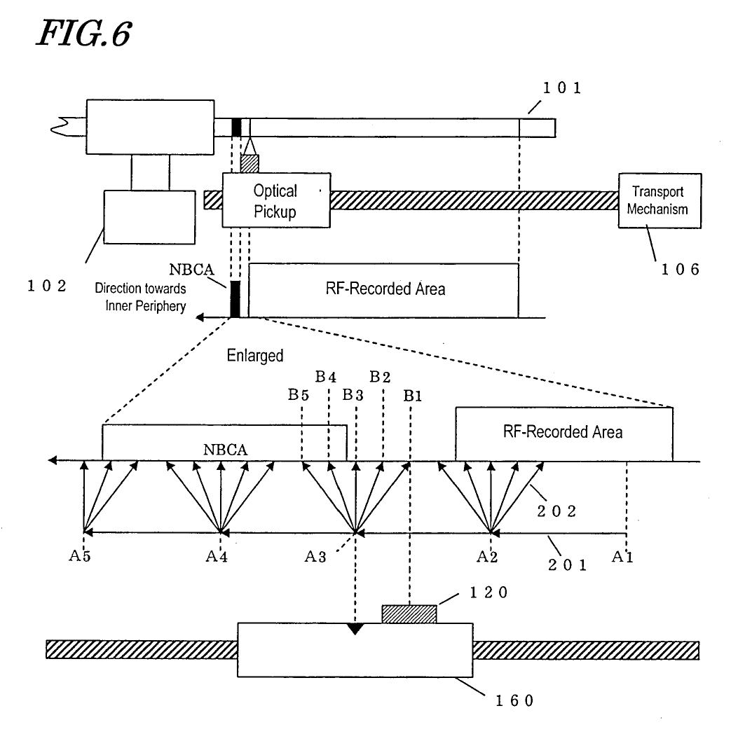

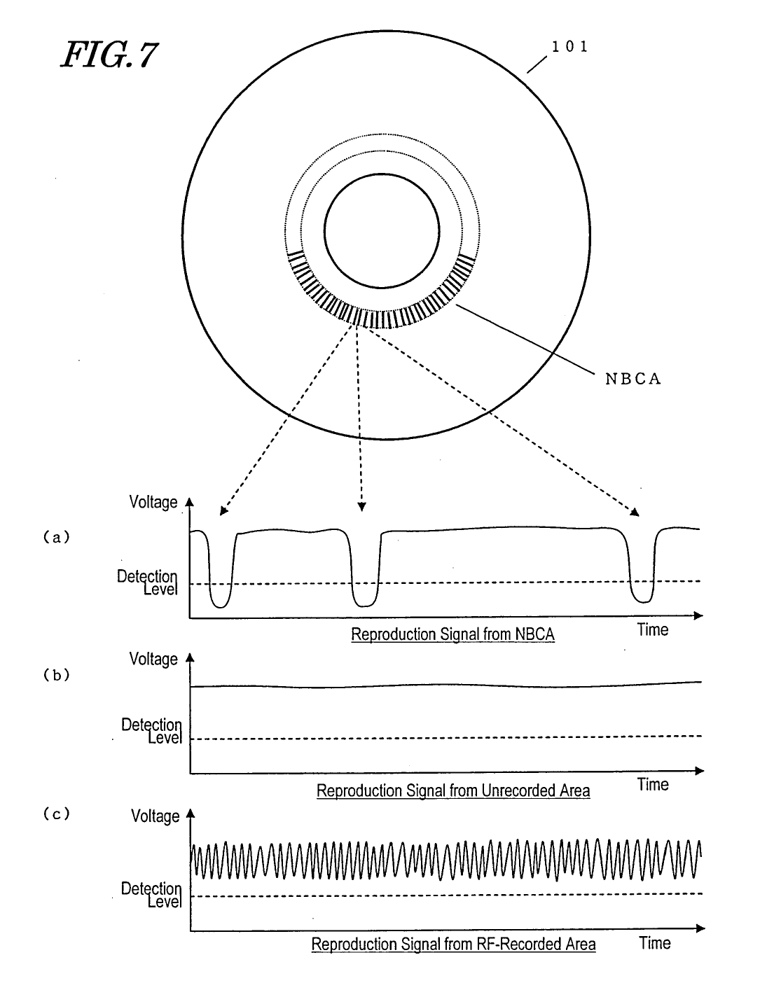

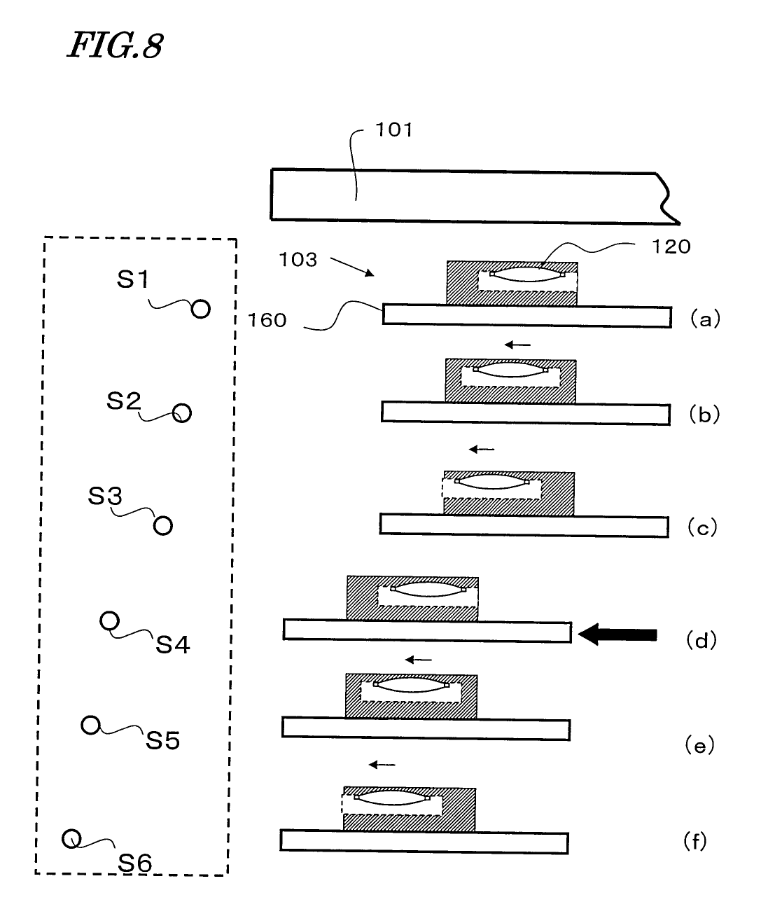

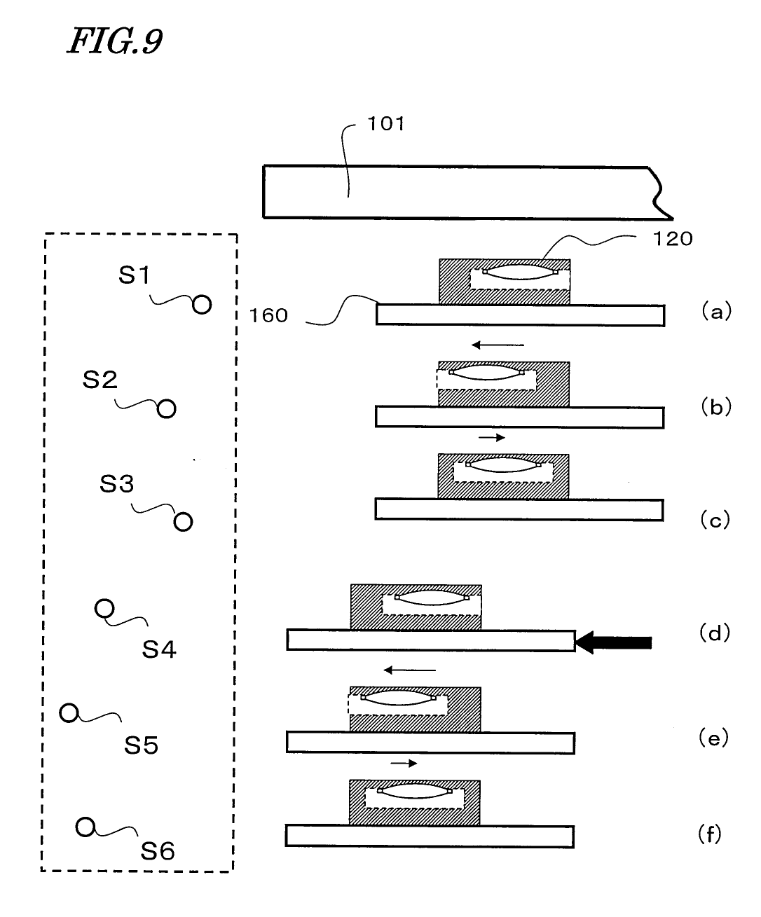

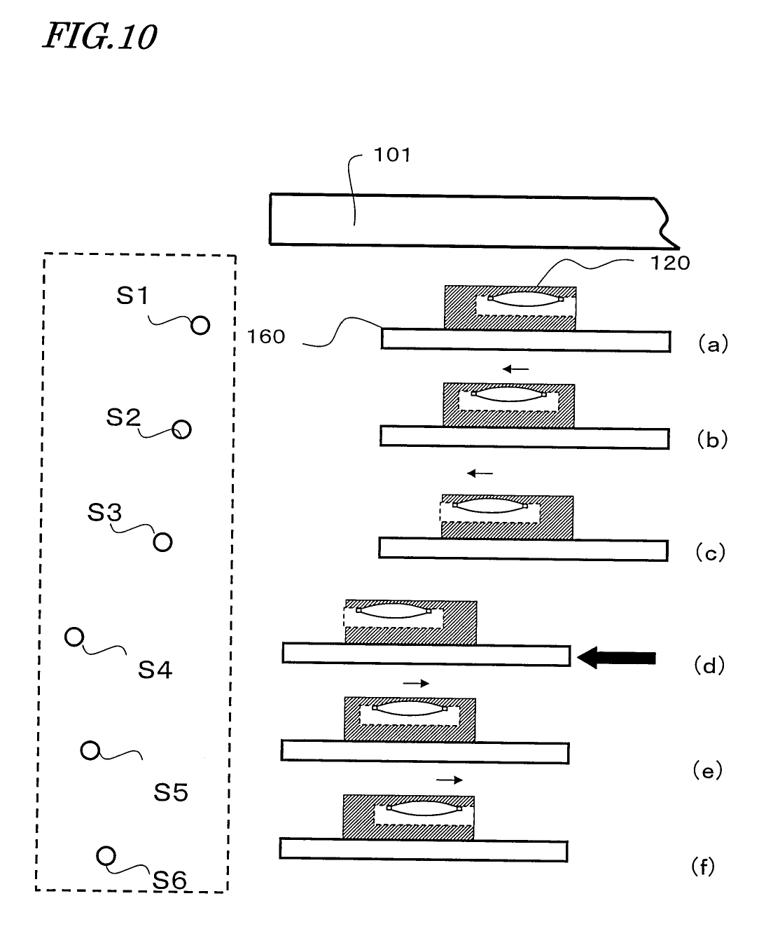

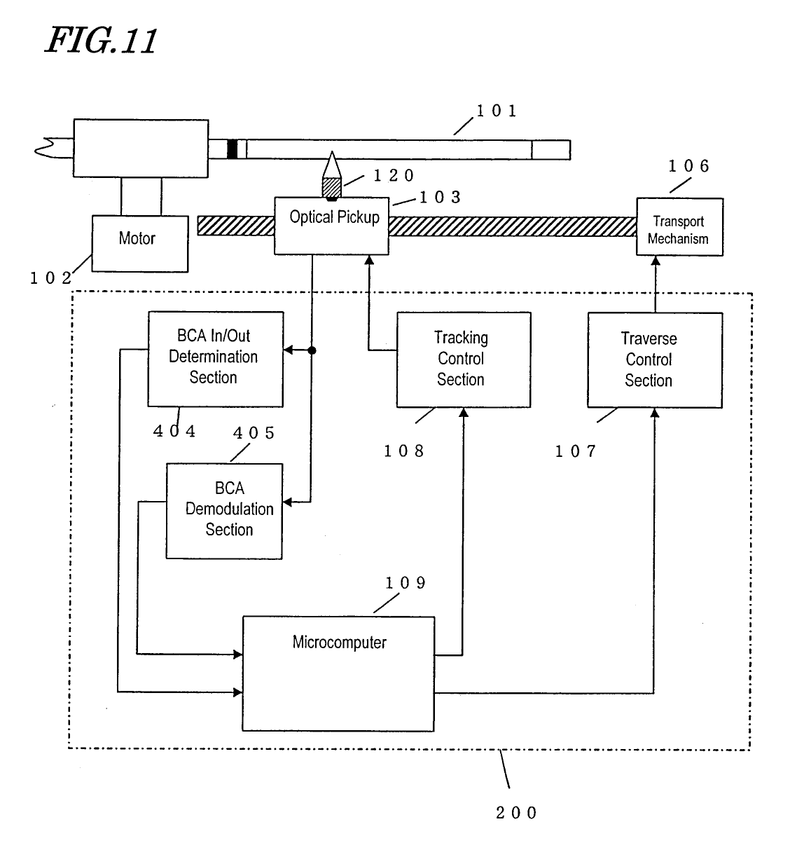

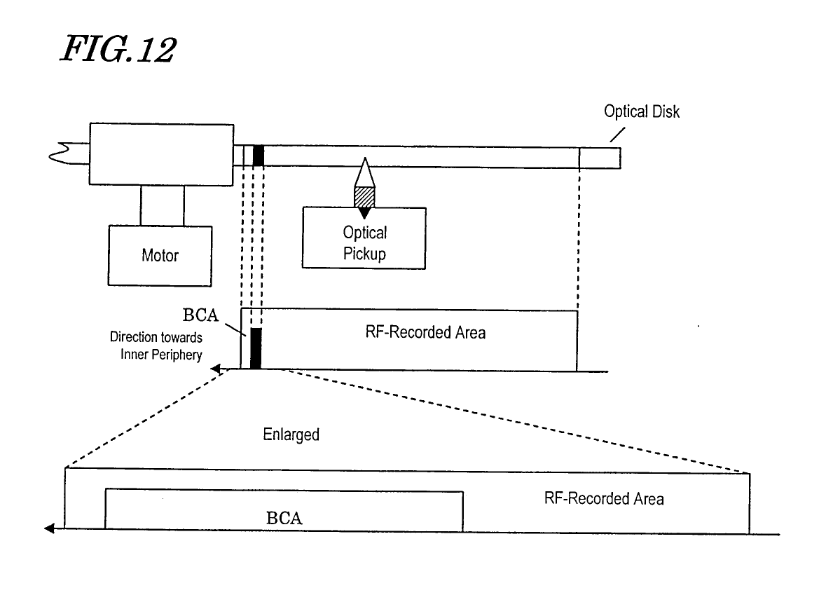

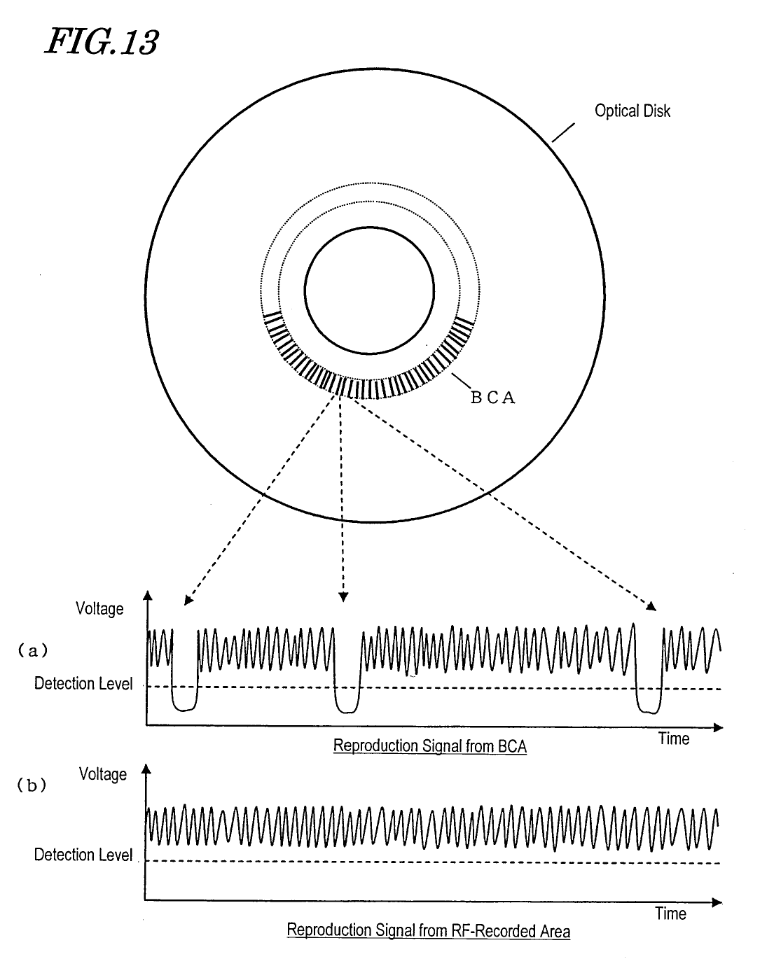

### BRIEF DESCRIPTION OF DRAWINGS

[FIG. 1] (a) is a plan view schematically showing an upper face of an optical disk 101 having a BCA or an NBCA; (b) is a partial cross-sectional view of the optical disk 101, schematically showing relative positions of a BCA and an RF-recorded area; and (c) is a partial cross-sectional view of the optical disk 101, schematically showing relative positions of an NBCA and an RF-recorded area.

[FIG. 2] A diagram showing the construction of a conventional optical disk reproduction apparatus.

[FIG. 3] A flowchart of a BCA read operation by a conventional optical disk reproduction apparatus.

[FIG. 4] A diagram showing a first embodiment of an optical disk reproduction apparatus according to the present invention.

[FIG. 5] (a) is a diagram showing moves along a tracking direction (a radial direction of an optical disk) shown by arrowheads X; and (b) is a diagram showing moves along a focusing direction (a direction perpendicular to the surface of an optical disk) shown by arrowheads Y. Arrowheads X are parallel to the radial direction of the optical disk, and are on the plane of the figure of (a), but are perpendicular to the plane of the figure of (b).

[FIG. 6] A diagram showing a process of moving the irradiated position of a light beam from an RF-recorded area to an NBCA of an optical disk.

[FIG. 7] (a) to (c) are waveform diagrams of reproduction signals which are obtained with an optical pickup.

[FIG. 8] (a) to (f) are diagrams schematically showing an example of transport operations for a base 160 and an objective lens 120.

[FIG. 9] (a) to (f) are diagrams schematically showing another example of transport operations for a base 160 and an objective lens 120.

[FIG. 10] (a) to (f) are diagrams schematically showing still another example of transport operations for a base 160 and an objective lens 120.

[FIG. 11] A diagram showing a second embodiment of an optical disk reproduction apparatus according to the present invention.

[FIG. 12] A diagram showing relative positions of an RF-recorded area and a BCA of an optical disk 101 having a BCA.

[FIG. 13] (a) and (b) are waveform diagrams of reproduction signals which are obtained with an optical pickup.

### DESCRIPTION OF THE REFERENCE NUMERALS

101 optical disk

102 motor

103 optical pickup

104 NBCA in/out determination section

105 NBCA demodulation section

106 transport mechanism

107 traverse control section

108 tracking control section

109 microcomputer

110a light source

110b photodetector

120 objective lens

130 lens holder

140 lens-supporting wire

150 support portion

160 base

200 control section

201 arrow indicating move of base

202 arrow indicating move of objective lens

404 BCA in/out determination section

405 BCA demodulation section

701 optical disk

702 motor

703 optical pickup

704 address demodulation section

705 BCA demodulation section

706 transport mechanism

707 traverse control section

708 tracking control section

709 microcomputer

710 tracking error signal detection section

### BEST MODE FOR CARRYING OUT THE INVENTION

In an optical disk reproduction apparatus according to the present invention, through a combination of a traverse operation by a transport mechanism (having a relatively low positioning accuracy) and shifting of an objective lens (which permits moves with a fine pitch), it becomes possible to securely move the irradiated position of a light beam to the NBCA, which exists in an area where no tracking error signal can be generated, this being possible without employing an expensive motor having a high positioning accuracy.

Note that, for simplicity, the term “Burst Cutting Area” in the present specification encompasses not only the usual “BCA”, but also the “NBCA”.

Hereinafter, preferred embodiments of the present invention will be described.

### Embodiment 1

With reference to FIG. 4, a first embodiment of an optical disk reproduction apparatus according to the present invention will be described. The optical disk reproduction apparatus of the present embodiment is able to read data (e.g., information that is unique to the disk) from the NBCA of an optical disk 101 having an NBCA.

This optical disk reproduction apparatus includes: a spindle motor 102 for rotating the optical disk 101; an optical pickup 103 for irradiating the optical disk 101 with a light beam, and generating an electrical signal from the reflected light therefrom; a transport mechanism 106 for moving a base of the optical pickup 103 along a radial direction of the optical disk 101; and a control section 200 for controlling the aforementioned constituent elements.

The control section 200 includes: an NBCA in/out determination section 104 for determining whether the irradiated position of the light beam is located within the NBCA area or not based on the electrical signal generated by the optical pickup 103; an NBCA demodulation section 105 for demodulating an NBCA signal from the aforementioned electrical signal; a traverse control section 107 for controlling the position of the optical pickup 103 by driving the transport mechanism 106; a tracking control section 108 for controlling the position of the objective lens in the optical pickup 103 along the radial direction of the optical disk 101; and a microcomputer 109 for controlling these operations.

Next, with reference to FIG. 5(a) and FIG. 5(b), driving of the objective lens 120 in the optical pickup 103 will be described. FIG. 5(a) is a diagram showing moves along a tracking direction (a radial direction of an optical disk) shown by arrowheads X, and FIG. 5(b) is a diagram showing moves along a focusing direction (a direction perpendicular to the surface of an optical disk) shown by arrowheads Y. A plane which is parallel to the plane of the figure of FIG. 5(b) is orthogonal to arrowheads X in FIG. 5(a). A lens actuator 170 shown in FIG. 5(b) would be located in front of the objective lens 120 in FIG. 5(a), but is omitted from description in FIG. 5(a) for simplicity.

As shown in FIG. 5(a) and FIG. 5(b), the optical pickup 103 includes: a light source 110a for emitting laser light; a photodetector 110b for receiving reflected light from the optical disk 101 and generating an electrical signal; the objective lens 120 for converging laser light onto the optical disk 101; a lens holder 130 for holding the objective lens 120; a support portion 150 for supporting the lens holder 130 via wires 140 having elastic force; a base 160 to which the support portion 150 is fixed; and the lens actuator 170 for moving the positions of the objective lens 120 and the lens holder 130 with respect to the base 160 along directions of arrowheads X and arrowheads Y.

The actual optical pickup 103 would include a beam splitter(s) and a phase difference plate(s) (not shown), which are known constituent elements and whose detailed descriptions are omitted. Although FIG. 5(a) and FIG. 5(b) show only one light source 101a and one objective lens 120, they may be provided in plurality.

The position of the base 160 along the direction of arrowheads X is controlled by the transport mechanism 106 shown in FIG. 4. The transport mechanism 106 of the present embodiment moves the optical pickup 103 with a DC motor. Specifically, the transport mechanism 106 includes a driving force transmission mechanism (not shown) which converts the rotary force of the DC motor to a linear motion by using gears and screws. With such a transport mechanism 106, the base 160 of the optical pickup 103 can be moved along the direction of arrowheads X with an interval of no less than about 300 μm, but its positioning accuracy is as coarse as about 150 to about 300 μm.

On the other hand, the positioning accuracy of the objective lens 120 with respect to the base 160 along the direction of arrowheads X is defined by the lens actuator 170, and is about 5 to about 10 μm even when tracking servo control in an OFF state. The lens actuator 170 forms a magnetic field in accordance with a supplied driving current, thus being able to highly precisely control, with a magnetic force, the relative position of the objective lens 120 against the base 160.

In the present embodiment, in order to surely bring the irradiated position of the light beam to the NBCA, a coarse transport operation (traverse operation) by the transport mechanism 106 and a fine transport operation (lens shift) of the objective lens 120 by the lens actuator 170 are combined.

Hereinafter, it will be described how a combination of these two types of transport operations makes it possible to surely bring the irradiated position of the light beam to the NBCA even when not performing tracking servo control.

First, FIG. 6 is referred to. FIG. 6 is a diagram showing a process of moving the irradiated position of a light beam from the RF-recorded area to the NBCA of the optical disk 101. As described earlier, the NBCA is located in an area (RF-unrecorded area) which is closer to the disk center than is the RF-recorded area.

In FIG. 6, arrows 201 indicate moves of the base 160 of the optical pickup, whereas arrows 202 indicate moves of the objective lens 120. Moreover, positions A1 to A5 indicate, respectively, the central positions (pickup positions) of the base 160 when the optical pickup 103 come to consecutive stops. Specifically, assuming that the center of the base 160 is initially at position A1, the base 160 may be consecutively moved from position A1 to position A2, and from position A2 to position A3, with the action of the transport mechanism 106. Although positions A1 to A5 are shown at equal intervals in the figure, in actuality, there are variations among these intervals because of the low positioning accuracy of the transport mechanism 106. Moreover, since the optical disk 101 has some eccentricity, the irradiated position of the light beam may also be deviated along the radial direction with the rotation of the optical disk 101. Therefore, when the base 160 is moved from position A1 to position A2 by the transport mechanism 106, for example, the actual location (position along the radial direction) of position A2 cannot be known exactly.

Since the positioning accuracy of the transport mechanism 106 is several hundred μm, when moving the irradiated position of the light beam from the RF-recorded area to the NBCA, an attempt to move the irradiated position of the light beam from the RF-recorded area to the NBCA in one time might incur the risk of allowing the irradiated position of the light beam to pass over the NBCA. Even if the irradiated position of the light beam can be moved from the RF-recorded area to the NBCA in one time, if NBCA data cannot be read at that position, as described earlier, the base 160 may not be able to be finely moved within the NBCA, depending on the particular transport mechanism 106.

Therefore, in the present embodiment, driving of the transport mechanism 106 is controlled as finely as possible to ensure sufficiently small intervals (about 300 μm) between positions A1 to A5; the position of the objective lens 120 is shifted with a high precision at each of positions A1 to A5 by the lens actuator 170; and it is detected whether the irradiated position of the light beam is located on the NBCA or not. For example, if the center of the base 160 is at position A3, the center of the objective lens 120 may be moved in five steps, from lens position B1 to lens position B5. The movable range of the objective lens 120 is about 300 μm or more along the disk radial direction, for example. If the number of moves of the objective lens 120 is set to four, the interval between positions B1 to B5 may be set to 300/5=60 μm. The travel distance of the objective lens 120 in one time must be set to be smaller than the travel distance of the optical pickup 103 in one time, and is preferably set within the range of no less than 10 μm and no more than 100 μm, for example. As the distance of the lens shift becomes shorter, the number of lens shifts will increase, thus resulting in a longer amount of time being required for completing the large number of shift operations. The number of lens shifts at each individual pickup position may be set to about 3 to about 30, for example.

In the example shown in FIG. 6, while the optical pickup 103 is at position A3, the irradiated position of the light beam is not at the NBCA when the objective lens 120 is at any of lens positions B1 to B3. However, when the objective lens 120 is at any of lens positions B4 to B5, the irradiated position of the light beam is on the NBCA.

It can be determined with the NBCA in/out determination section 104 shown in FIG. 4 as to whether the irradiated position of the light beam is on the NBCA or not. Every time the position of the optical pickup 103 is brought closer to the disk center by the transport mechanism 106 and the position of the objective lens 120 is changed at each pickup position, it must be determined in the NBCA in/out determination section 104 as to whether the irradiated position of the light beam is on the NBCA not. Hereinafter, the operation of the NBCA in/out determination section 104 will be described with reference to FIG. 7.

FIGS. 7(a) to (c) are waveform diagrams of reproduction signals which are obtained with the optical pickup 103. In the RF-recorded area of the optical disk 101, a large number of recording marks having a relatively low reflectance are formed; therefore, as shown in FIG. 7(c), a reproduction signal which is obtained from the RF-recorded area fluctuates with a high frequency. On the other hand, in the RF-unrecorded area of the optical disk 101, the reflectance is maintained at a high and constant value; therefore, as shown in FIG. 7(b), a reproduction signal which is obtained from the RF-unrecorded area is substantially constant. However, from the NBCA, i.e., a portion of the RF-unrecorded area where slits are formed in the reflection film, a reproduction signal whose amplitude is reduced in the slit portions is obtained, as shown in FIG. 7(a).

Therefore, as shown in FIG. 7(a) to FIG. 7(c), by setting the detection level (threshold value) to an appropriate value, and measuring the periods (corresponding to the slit portions) during which the level of the reproduction signal is equal to or less than the detection level, it becomes possible to detect whether the irradiated position of the light beam is on the NBCA or not. This “detection level” needs to be set to a level for detecting a decrease in the intensity of reflected light at the slit portions (i.e., portions where the reflection film is removed) of the NBCA, and is set to a value which is lower than the intensity of reflected light in the areas where the reflection film exists and higher than the intensity of reflected light from the slit portions of the NBCA. This detection level may be changed as appropriate in accordance with the type of the optical disk.

In the present embodiment, when the proportion of the periods during which the reproduction signal stays equal to or less than the detection level becomes equal to or greater than a predefined value (e.g., 8.3%), it is determined that the irradiated position of the light beam is at the NBCA. The reason for not immediately determining the irradiated position of the light beam to be within the “NBCA” area when the reproduction signal becomes equal to or less than the detection level for a short period of time is that the light amount of the reflected light may have a temporary decrease when the light beam traverses a scratch or a dust particle existing on the surface of the optical disk 101. Thus, it is ensured that such cases will not be wrongly determined as being “within the NBCA area”.

The determination operation by the NBCA in/out determination section 104 can be executed without reading any information that is actually recorded in the NBCA, and thus enables a rapid determination. In order to read any information that is recorded in the NBCA, it would be necessary to demodulate the BCA data based on the reproduction signal, thus resulting in extra time being spent.

Next, with reference to FIG. 8(a) to FIG. 8(f), the transport operations for the base 160 of the pickup 103 and the objective lens 120 will be specifically described. FIG. 8(a) to FIG. 8(f) are diagrams schematically describing transport operations for the base 160 and the objective lens 120. FIG. 8(a) shows the positions of the base 160 and the objective lens 120 at the start of the transport operations, and FIG. 8(b) shows the positions of the base 160 and the objective lens 120 after the lapse of a predetermined time (e.g., 20 milliseconds to 40 milliseconds). FIG. 8(c) to FIG. 8(f) show how the transport operations are consecutively executed. In the frame of broken lines in the left-hand side of FIG. 8, spots S1 to S6 schematically represent the irradiated positions of the light beam in FIG. 8(a) to FIG. 8(f), respectively. It is indicated, the irradiated position of the light beam is moved toward the left (toward the disk center) with lapse of time.

In the present embodiment, as shown in FIG. 8(a) to FIG. 8(c), after the base 160 is moved to a first pickup position, the objective lens 120 is moved toward the disk center without moving the base 160. This move of the objective lens 120 is performed by the lens actuator 170 included in the optical pickup 103, and thus provides a high positioning accuracy.

Next, the base 160 is moved to a second pickup position which is closer to the disk center as shown in FIG. 8(d), and also the objective lens 120 is moved in a direction away from the disk center. Since the move of the optical pickup 103 is performed by the transport mechanism 106, it is difficult to accurately know its travel distance.

Thereafter, as shown in FIG. 8(e) to FIG. 8(f), the objective lens 120 is moved toward the disk center without moving the base 160.

While performing the above-described transport operations, detection of the NBCA by the NBCA in/out determination section 104 is carried out. In the example shown in FIG. 6, the NBCA will be detected by the NBCA in/out determination section 104 when the objective lens 120 comes to lens position B4 while the optical pickup 103 is at position A3. Note that the NBCA detection process itself may be performed not only when the objective lens 120 (lens shift) has been moved within the optical pickup 103, but also when the base 160 has been moved.

Next, with reference to FIG. 4 and FIG. 6, an initial operation of the optical disk reproduction apparatus of the present embodiment will be described.

Upon boot, or when the optical disk 101 is loaded, the optical disk reproduction apparatus of the present embodiment first reads control data from the optical disk 101 to determine whether the loaded optical disk 101 is an optical disk having an NBCA or not. The control data is a portion of the main information, and is recorded as an RF signal. In the example of FIG. 6, the optical pickup is at position A1 while reading the control data, and tracking servo control is in operation.

When beginning read of the NBCA, the microcomputer 109 keeps the tracking control by the tracking control section 108 in an OFF state. Next, the traverse control section 107 is employed to move the base 160 in a direction towards the inner periphery of the optical disk 101. Although a predetermined level of current or voltage is supplied to the DC motor of the transport mechanism 106 for a predetermined period, the resultant travel distance of the optical pickup 103 has a low reproducibility as described earlier, and is liable to variation. In the example of FIG. 6, the optical pickup 103 moves to position A2.

Thereafter, by using the tracking control section 108, the objective lens 120 is moved to a plurality of different lens positions B1 to B5 along the radial direction of the optical disk 101. The order of moving the objective lens 120 among lens positions B1 to B5 may be arbitrary. For example, after first locating the objective lens 120 at lens position B1, which is at the outermost peripheral side, it is determined with the NBCA in/out determination section 104 as to whether the irradiated position of the light beam is within the NBCA or not. If it is determined to be outside the NBCA, the objective lens 120 is moved in a direction towards the inner periphery, and an NBCA in/out determination is performed at lens position B2.

The distance traveled by the objective lens 120 in one move is shorter than the distance traveled by the base 160 moves in one move.

Through a combination of the relatively coarse move of the base 160 and the relatively fine move of the objective lens 120, it becomes possible to introduce fine changes in the irradiated position of the light beam. In the present embodiment, NBCA in/out determinations are made while moving the irradiated position of the light beam from the RF-recorded area with a fine pitch, and thus the NBCA can be surely detected.

Once the irradiated position of the light beam has arrived on the NBCA, the NBCA data is read by the NBCA demodulation section 105. Note that, in the case where the irradiated position of the light beam is close to the end of the NBCA toward the disk's outer periphery, the irradiated position of the light beam may deviate from the NBCA with the rotation of the optical disk 101 if the optical disk 101 is eccentric. In order to surely read the NBCA data, it is preferable that the irradiated position of the light beam is close to the central portion of the NBCA, rather than to the end of the NBCA toward the disk's outer periphery.

The irradiated position of the light beam being near the end of the NBCA toward the disk's outer periphery can be detected when the waveform of FIG. 7(a) and the waveform of FIG. 7(b) alternately appear. In other words, if the periods (corresponding to the slit portions) during which the level of the reproduction signal is equal to or less than the detection level do not exceed a predetermined period, it can be determined that the irradiated position of the light beam is deviated from the NBCA. In such a case, before performing a read operation of the NBCA data, the irradiated position of the light beam is preferably moved toward the central portion of the NBCA. Specifically, the objective lens 120 may be shifted within the optical pickup 103 by a minute distance (e.g., about several tens of μm to about 100 μm) toward the disk's inner periphery side, or the optical pickup 103 itself may be moved toward the disk's inner periphery side. However, since the move of the optical pickup 103 needs to be performed by the transport mechanism 106, it is difficult to set the minimum travel distance to 300 μm or less, and the positioning accuracy is as poor as about 150 to about 300 μm. Based on the fact that the NBCA has a width of about 800 μm, it is preferable to move the objective lens 120 toward the disk's inner periphery side, without moving the optical pickup 103. If it is detected that the irradiated position of the light beam has reached the NBCA, the objective lens 120 may be universally moved by a predetermined distance toward the disk's inner periphery side, irrespective of whether the irradiated position of the light beam is near the outer periphery of the disk or not.

Thus, after the irradiated position of the light beam has surely come within the NBCA, the NBCA data is read by the NBCA demodulation section 105, and if a successful read of the NBCA data is made, the NBCA read operation is ended. However, in some cases, the NBCA data may not be read because of a scratch or the like existing on the NBCA. In such cases, the irradiated position of the light beam is further moved by a minute distance toward the disk's inner periphery side, and a read of the NBCA data is retried. As a result of consecutive instances of being unable to read the NBCA, if the irradiated position of the light beam has gone outside the NBCA, moving of irradiated position of the light beam is stopped. Thereafter, a move to the RF-recorded area is made, and a reproduction operation which does not require the NBCA information is begun for the RF-recorded area.

Thus, in accordance with the optical disk reproduction apparatus of the present embodiment, even when tracking servo control is unavailable in a portion where the RF signal is unrecorded, it is possible to read the NBCA without employing an expensive motor to enhance the positioning accuracy of the transport mechanism.

Note that the order of moving the objective lens 120 among a plurality of lens positions at the stop position of the optical pickup 103 is not limited to the above-described example. For example, as shown in FIG. 9(a) to FIG. 9(f), at each pickup position, after being moved from the outermost periphery side to the innermost periphery side, the objective lens 120 may be returned to the central position. Moreover, as shown in FIG. 10(a) to FIG. 10(f), the move direction of the objective lens 120 may be reversed at each pickup position. Furthermore, the number of lens positions at each pickup position only needs to be plural, without being limited to three or five.

Moreover, when first moving the optical pickup 103 from the RF-recorded area toward the NBCA, the travel distance of the optical pickup 103 may be set so that it will come into the NBCA in a single move. In that case, after the first move of the optical pickup 103, an area determination is performed, and upon determining that the irradiated position of the light beam is within the NBCA, the NBCA data may be read without performing any lens shift at that position. In some cases, the NBCA data may not be read at that position due to dust particles, scratches, or other causes. In such cases, while keeping the optical pickup 103 stopped, a lens shift may be made by a minute distance (e.g., 10 to 100 μm), and thereafter a read of the NBCA data may be performed. If it is determined that the irradiated position of the light beam has deviated outside the NBCA as a result of such a lens shift, a lens shift may be performed so that the irradiated position of the light beam will return into the NBCA, and the NBCA data may be read after returning into the NBCA.

### Embodiment 2

Hereinafter, a second embodiment of an optical disk reproduction apparatus according to the present invention will be described.

First, FIG. 11 is referred to. FIG. 11 is a block diagram of the optical disk reproduction apparatus of the present embodiment.

The construction of the optical disk reproduction apparatus of the present embodiment differs from the construction of the optical disk reproduction apparatus of Embodiment 1 in that the optical disk reproduction apparatus of the present embodiment includes a BCA in/out determination section 404 and a BCA demodulation section 405, instead of the NBCA in/out determination section 104 and the NBCA demodulation section 105. Since the other constituent elements are common between the two embodiments, such common portions will be omitted from description herein.

Based on a reproduction signal from the optical pickup 103, the BCA area determination section 404 determines whether the irradiated position of the light beam is located within the BCA area or not. Based on the reproduction signal from the optical pickup 103, the BCA demodulation section 405 demodulates a BCA signal.

FIG. 12 shows relative positions of an RF-recorded area and a BCA of an optical disk 101 having a BCA. Since the BCA exists within the RF-recorded area, it might be possible to generate a tracking error signal from the BCA and perform tracking servo control. However, according to the present embodiment, when reading the BCA data, tracking servo control is kept in an OFF state at the inner periphery side within the RF-recorded area. Thereafter, by combining transport operations for the optical pickup 103 and the objective lens 120 with a method similar to the method that has been described with respect to Embodiment 1, determinations by the BCA in/out determination section 404 are performed while moving the irradiated position of the light beam toward the BCA by minute distances, and therefore the BCA can be detected with a high accuracy.

FIG. 13 is a waveform diagram of reproduction signals obtained with the optical pickup 103. The detection level is a threshold value against which the BCA in/out determination section 404 determines being inside or outside the BCA. If the proportion of time of being equal to or less than the detection level accounts for a predefined ratio or greater, a determination is made that it is inside the BCA. Thus, the BCA in/out determination section 404 has a similar function to that of the NBCA in/out determination section 104.

FIG. 13(a) and FIG. 13(b) are waveform diagrams of reproduction signals which are obtained with the optical pickup 103. In the RF-recorded area of the optical disk 101, a large number of recording marks having a relatively low reflectance are formed; therefore, as shown in FIG. 13(b), a reproduction signal which is obtained from the RF-recorded area fluctuates with a high frequency. From the BCA, i.e., a portion of the RF-recorded area where slits are formed in the reflection film, a reproduction signal whose amplitude is reduced in the slit portions is obtained, as shown in FIG. 7(a).

Therefore, as shown in FIG. 13(a) and FIG. 13(b), by setting the detection level (threshold value) to an appropriate value, and measuring the periods (corresponding to the slit portions) during which the level of the reproduction signal is equal to or less than the detection level, it becomes possible to detect whether the irradiated position of the light beam is on the BCA or not. This “detection level” needs to be set to a level for detecting a decrease in the intensity of reflected light at the slit portions (i.e., portions where the reflection film is removed) of the BCA, and is set to a value which is lower than the intensity of reflected light in the areas where the reflection film exists and higher than the intensity of reflected light from the slit portions of the BCA.

In the present embodiment, when the proportion of the periods during which the reproduction signal stays equal to or less than the detection level becomes equal to or greater than a predefined value (e.g., 8.3%), it is determined that the irradiated position of the light beam is at the BCA. Thus, the BCA in/out determination section 404 operates in a similar manner to the NBCA in/out determination section 104, and upon determining that the irradiated position of the light beam is on the BCA, the BCA demodulation section 405 demodulates the BCA data. Note that tracking servo control is kept in an OFF state during the BCA in/out determination and the BCA data demodulation.

Thus, not only when reading the NBCA but also when reading the BCA, it is possible to move the irradiated position of the light beam to the BCA while keeping OFF the tracking servo control, and read the BCA. According to the present embodiment, a stable read of the BCA can be achieved without performing tracking servo control, whose operation is likely to become unstable due to the presence of the BCA.

The NBCA in/out determination section 104 and the BCA in/out determination section 404 in the above embodiments function as an “area determination means” according to the present invention. However, the area determination means is not limited to those having the constructions according to the above embodiments. For example, it would be possible to adopt a construction which, based on whether the Burst Cutting Area information can be decoded or not, determines whether the irradiated position of the light beam is located within the Burst Cutting Area or not.

Note that the constitution of the control section 200 in the above embodiments may be implemented in hardware, or implemented by a combination of hardware and software.

### INDUSTRIAL APPLICABILITY

An optical disk reproduction apparatus according to the present invention makes it possible to read the NBCA even if the transport mechanism of an optical pickup has an inexpensive motor, and thus is useful for allowing optical disk reproduction apparatuses to gain prevalence.

1. An optical disk reproduction apparatus for, from an optical disk having an Burst Cutting Area, reading information from the Burst Cutting Area, comprising:
an optical pickup having: a light source for emitting a light beam, an objective lens for converging the light beam onto the optical disk, a lens actuator for controlling a position of the objective lens, and a photodetector for generating an electrical signal from at least a portion of the light beam having been reflected by the optical disk;
a transport mechanism for moving the optical pickup along a radial direction of the optical disk; and
area determination means for, based on the electrical signal, determining whether an irradiated position of the light beam on the optical disk is located within the Burst Cutting Area, wherein,
when reading information from the Burst Cutting Area, the optical disk reproduction apparatus executes:
step A of, by using the transport mechanism, moving the optical pickup from a first pickup position to a second pickup position which is close to the disk center;
step B of, by using the lens actuator, placing the objective lens consecutively at a plurality of different lens positions within the optical pickup being at the second pickup position; and
step C of, by using the area determination means, determining whether an irradiated position on the optical disk of the light beam converged by the objective lens is located within the Burst Cutting Area or not, wherein,
when it is determined at step C that the irradiated position of the light beam on the optical disk is not located within the Burst Cutting Area, the optical disk reproduction apparatus executes:
step D of, by using the transport mechanism, bringing the optical pickup further closer to the disk center;
step E of, by using the lens actuator, placing the objective lens consecutively at a plurality of different lens positions within the optical pickup; and
step F of, by using the area determination means, determining whether an irradiated position on the optical disk of the light beam converged by the objective lens is located within the Burst Cutting Area or not.

2. The optical disk reproduction apparatus of claim 1, wherein an interval between the plurality of lens positions within the optical pickup is set to be shorter than a distance from the first pickup position to the second pickup position.

3. (canceled)

4. The optical disk reproduction apparatus of claim 1, wherein an interval between the plurality of lens positions within the optical pickup is set to be shorter than a distance traveled by the optical pickup at step D.

5. The optical disk reproduction apparatus of claim 1, wherein, when placing the objective lens consecutively at a plurality of different lens positions within the optical pickup by using the lens actuator, the optical disk reproduction apparatus executes a step of bringing the objective lens closer to the disk center, the step being executed a plurality of times.

6. The optical disk reproduction apparatus of claim 5, wherein, when placing the objective lens consecutively at a plurality of different lens positions within the optical pickup by using the lens actuator, the optical disk reproduction apparatus executes a step of bringing the objective lens away from the disk center, the step being executed at least once.

7. The optical disk reproduction apparatus of claim 1, wherein the first pickup position is located more toward an outer periphery of the disk than an innermost peripheral edge of a reproduction signal recorded area.

8. The optical disk reproduction apparatus of claim 1, wherein, based on a change in the light amount of the light beam having been reflected by the optical disk, the area determination means determines whether the irradiated position of the light beam on the optical disk is located within the Burst Cutting Area or not.

9. The optical disk reproduction apparatus of claim 1, wherein, if the irradiated position of the light beam on the optical disk is determined to be located within the Burst Cutting Area, the optical disk reproduction apparatus executes, before reading information from the Burst Cutting Area, an operation of bringing the irradiated position of the light beam closer to a central portion of the Burst Cutting Area.

10. The optical disk reproduction apparatus of claim 1, wherein the Burst Cutting Area is a Narrow Burst Cutting Area.

11. The optical disk reproduction apparatus of claim 1, wherein the transport mechanism includes a DC motor, and the optical pickup is moved along the radial direction of the optical disk by a rotation of the DC motor.

12. A driving method for an optical disk reproduction apparatus which includes an optical pickup having: a light source for emitting a light beam, an objective lens for converging the light beam onto the optical disk, a lens actuator for controlling a position of the objective lens, and a photodetector for generating an electrical signal from at least a portion of the light beam having been reflected from the optical disk, the driving method comprising:
when reading, from an optical disk having a Burst Cutting Area, information from the Burst Cutting Area,
step A of moving the optical pickup from a first pickup position to a second pickup position which is close to the disk center;
step B of, by using the lens actuator, placing the objective lens consecutively at a plurality of different lens positions within the optical pickup being at the second pickup position; and step C of determining whether an irradiated position on the optical disk of the light beam converged by the objective lens is located within the Burst Cutting Area or not, wherein,
when it is determined at step C that the irradiated position of the light beam on the optical disk is not located within the Burst Cutting Area, the following steps are executed:
step D of bringing the optical pickup further closer to the disk center;
step E of, by using the lens actuator, placing the objective lens consecutively at a plurality of different lens positions within the optical pickup; and
step F of determining whether an irradiated position on the optical disk of the light beam converged by the objective lens is located within the Burst Cutting Area or not.
